(19) United States
(12) Patent Application Publication
(10) Pub. No.: US 2020/0097743 A1
(43) Pub. Date: Mar. 26, 2020

(54) RIDING MANNER EVALUATION APPARATUS, RIDING MANNER EVALUATION SYSTEM, AND RIDING MANNER EVALUATION METHOD

(71) Applicant: TOYOTA JIDOSHA KABUSHIKI KAISHA, Toyota-shi (JP)

(72) Inventors: Takahiro SHIGA, Chiryu-shi (JP); Mami KATO, Toyota-shi (JP); Masato ENDO, Nagakute-shi (JP)

(73) Assignee: TOYOTA JIDOSHA KABUSHIKI KAISHA, Toyota-shi (JP)

(21) Appl. No.: 16/528,933

(22) Filed: Aug. 1, 2019

(30) Foreign Application Priority Data
Sep. 21, 2018 (JP) 2018-178133

(51) Int. Cl. G06K 9/00; G10L 25/51; H04N 7/18

(52) U.S. Cl. CPC G06K 9/00832; G06K 9/00718; G05D 1/0088; H04N 7/183; G10L 25/51

(57) ABSTRACT

A riding manner evaluation apparatus includes a memory; and a processor configured to detect a feature indicating the possibility of inappropriate behavior by a passenger riding in a vehicle, from interior compartment information representing the state of a compartment of the vehicle captured by a capture device installed in the vehicle that is under automatic driving control; and collect, whenever the feature is detected, the interior compartment information captured in a predetermined interval including the time when the feature is detected.

### FIELD

The present invention relates to a riding manner evaluation apparatus, a riding manner evaluation system, and a riding manner evaluation method that can evaluate the riding manners of a passenger riding in a vehicle that is under automatic driving control.

### BACKGROUND

In recent years, automatic driving technologies with the aim of realizing mobility services including taxi, bus, and ride sharing services using automatic driving vehicles that are driven under automatic control have been developed.

For example, a non-patent literature (TOYOTA MOTOR CORPORATION, Mobility Service-specific EV “e-Palette Concept” [retrieved on Aug. 31, 2018], Internet<URL:https://newsroom.toyota.co.jp/jp/corporate/20508200.html>) describes a vehicle that enables a manufacturer other than the maker of the vehicle to develop an automatic driving kit including software for automatic driving control for the vehicle, by disclosing a vehicle control I/F (interface) for controlling the vehicle. Since the automatic driving kit is configured to be replaceable or updatable, the automatic driving control can be optimized in conformance with Mobility-as-a-Service (MaaS) in the fields of movement, logistics, product sales, and the like.

Although automatic driving vehicles have the advantage that crew members such as drivers are unnecessary, the automatic driving vehicles also have the disadvantage that, for example, if a passenger exits the vehicle leaving behind belongings, there are no crew members to find such possessions and inform the passenger as such. In the technology described in Japanese Patent Publication (Kokai) No. 2013-191053, for example, the current state of the interior of a vehicle is captured as current video data, and the current video data is compared with video data stored in advance. When any difference is detected therebetween, a change of the interior of the vehicle is inspected, and a predetermined message is sent to the interior of the vehicle based on the difference, in order to warn a user to take his or her belongings.

### SUMMARY

However, warning a user not to leave his or her belongings behind is effective when the user unintendedly leaves his or her belongings behind, as in the case of Japanese Patent Publication (Kokai) No. 2013-191053, but is not particularly effective when the user purposely leaves unwanted items, such as trash, behind in the vehicle. Users who frequently behave inappropriately, e.g., purposefully leaving trash and the like behind in vehicles, must not only be warned but also penalized, such as refusing use of mobility service provided by the vehicle by the users in the future. Therefore, technologies to evaluate the riding manners of users of the vehicles that are under automatic driving control and to identify users who frequently behave inappropriately have been demanded.

The present invention aims to provide a riding manner evaluation apparatus that can evaluate the riding manners of a passenger using a vehicle that is under automatic driving control.

A riding manner evaluation apparatus according to an embodiment of the present invention includes a memory; and a processor configured to detect a feature indicating the possibility of inappropriate behavior by a passenger riding in a vehicle, from interior compartment information representing the state of a compartment of the vehicle captured by a capture device installed in the vehicle that is under automatic driving control; and collect, whenever the feature is detected, the interior compartment information captured in a predetermined interval including the time when the feature is detected.

In the riding manner evaluation apparatus, the processor preferably determines whether or not the passenger has behaved inappropriately based on the interior compartment information stored in the memory, and that evaluates the riding manners of the passenger in accordance with the number of times the passenger is determined to have behaved inappropriately.

In the riding manner evaluation apparatus, the capture device preferably includes an imaging device installed in the vehicle. The interior compartment information preferably includes a video of the compartment of the vehicle captured by the imaging device. The processor preferably detects, from the video, an appearance of a predetermined object indicating the possibility of the inappropriate behavior, a change in the shape or color of a predetermined fixture in the vehicle, or whether the distance between the passenger and another passenger has been reduced to a predetermined threshold value or less, as the feature.

In the riding manner evaluation apparatus, the capture device preferably includes a sound collection device installed in the vehicle. The interior compartment information preferably includes sound in the compartment of the vehicle recorded by the sound collection unit. The processor preferably detects whether the average value of the sound level in a predetermined time has exceeded a predetermined threshold value, as the feature.

In the riding manner evaluation apparatus, the capture device preferably includes an odor sensor installed in the vehicle. The interior compartment information preferably includes a measurement value of a predetermined odor component measured by the odor sensor. The processor preferably detects whether the measurement value has exceeded a predetermined threshold value, as the feature.

In the riding manner evaluation apparatus, the riding manner evaluation apparatus is preferably configured as a server that receives the interior compartment information from the vehicle including the capture device through a network.

In the riding manner evaluation apparatus, the riding manner evaluation apparatus is preferably configured as a vehicle-mounted device that is installed in the vehicle together with the capture device.

A riding manner evaluation system according to an embodiment of the present invention includes a server and a vehicle-mounted device that are communicatively connected to each other through a network. The riding manner evaluation system includes the vehicle-mounted device that detects a feature indicating the possibility of inappropriate behavior by a passenger riding in a vehicle, from interior compartment information representing the state of a compartment of the vehicle captured by a capture device installed in the vehicle that is under automatic driving control, and that sends, when the feature is detected, the interior compartment information captured in a predetermined interval including the time when the feature is detected, to the server; and the server that stores the interior compartment information received from the vehicle-mounted device in a memory.

A riding manner evaluation method according to an embodiment of the present invention includes the steps of detecting a feature indicating the possibility of inappropriate behavior by a passenger riding in a vehicle, from interior compartment information representing the state of a compartment of the vehicle captured by a capture device installed in the vehicle that is under automatic driving control; and storing, each time the feature is detected, the interior compartment information that is obtained in a predetermined interval including the time when the feature is detected, in a memory.

The object and advantages of the invention will be realized and attained by means of the elements and combinations particularly pointed out in the claims. It is to be understood that both the foregoing general description and the following detailed description are exemplary and explanatory, and are not restrictive of the invention, as claimed.

### BRIEF DESCRIPTION OF DRAWINGS

FIG. 1 is a drawing showing an example of the configuration of a riding manner evaluation system according to a first embodiment.

FIG. 2 is a sequence diagram showing an example of a riding manner evaluation process of a passenger who is riding in a vehicle that is under automatic driving control, in the riding manner evaluation system according to the first embodiment.

FIG. 3 is a hardware configuration diagram of the vehicle according to the first embodiment.

FIG. 4 is a functional block diagram of a controller of a vehicle-mounted device according to the first embodiment.

FIG. 5 is a flowchart showing an example of a process for collecting interior compartment information by the vehicle-mounted device according to the first embodiment.

FIG. 6 is a drawing showing an example of the state of a compartment in which a passenger is behaving inappropriately in the vehicle according to the first embodiment.

FIG. 7 is a drawing showing another example of the state of the compartment in which the passenger is behaving inappropriately in the vehicle according to the first embodiment.

FIG. 8 is a hardware configuration diagram of a server according to the first embodiment.

FIG. 9 is a functional block diagram of a controller of the server according to the first embodiment.

FIG. 10 is a functional block diagram of a controller of a server according to a second embodiment.

FIG. 11 is a flowchart showing an example of a process for collecting interior compartment information by the server according to the second embodiment.

### DESCRIPTION OF EMBODIMENTS

A riding manner evaluation apparatus according to the present invention detects a feature indicating the possibility of inappropriate behavior such as littering by a passenger who is riding in a vehicle, from interior compartment information such as a video displaying the state of a compartment of the vehicle captured by, for example, an in-vehicle camera installed in the vehicle that is under automatic driving control. Whenever the feature indicating the possibility of the inappropriate behavior is detected, the riding manner evaluation apparatus stores the interior compartment information captured in a predetermined interval including the time when the feature is detected, in a memory.

The riding manner evaluation apparatus according to the present invention thereby enables an evaluation unit of the riding manner evaluation apparatus or a human to evaluate the riding manners of passengers using the vehicle that is under the automatic driving control, based on the interior compartment information stored in the memory, and to identify passengers who frequently behave inappropriately.

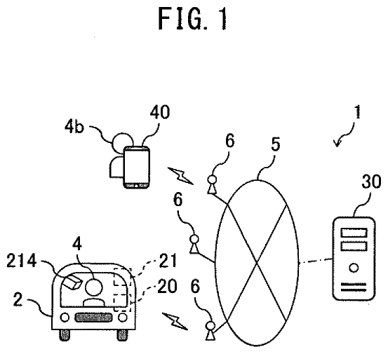

Preferred embodiments of the present invention will be described below with reference to the drawings. Note that, the present invention is not limited to the following embodiments, but may be appropriately modified without departing from the gist thereof. In the drawings, components having the same or similar functions have been assigned the same reference numerals, and descriptions thereof may be omitted or simplified.

[First Embodiment] FIG. 1 is a drawing showing an example of the configuration of a riding manner evaluation system 1 according to a first embodiment. The riding manner evaluation system 1 according to the present embodiment includes a vehicle-mounted device 20, a server 30, and a mobile terminal 40. The vehicle-mounted device 20 and the server 30 of the present embodiment are an example of the riding manner evaluation apparatus.

A vehicle 2 illustrated in FIG. 1 is an automatic driving vehicle that offers mobility services such as a taxi, bus, or ride sharing services. The vehicle-mounted device 20 and an automatic driving control module 21 are installed in the vehicle 2. A passenger 4 using the mobility service rides in the vehicle 2.

The vehicle-mounted device 20 detects a feature indicating the possibility of inappropriate behavior such as littering by the passenger 4 who is riding in the vehicle 2, from interior compartment information including a video of a compartment of the vehicle 2 captured by, for example, an in-vehicle camera 214 installed in the vehicle 2 that is under automatic driving control. When the feature indicating the possibility of inappropriate behavior is detected, the riding manner evaluation apparatus sends the interior compartment information captured in a predetermined interval including the time when the feature is detected to the server 30.

The automatic driving control module 21 automatically controls the driving of the vehicle 2. The automatic driving control module 21 is configured so that the performance and function of the automatic driving control can be updated.

The server 30 determines whether or not the passenger 4 has behaved inappropriately based on the interior compartment information received from the vehicle-mounted device 20. The server 30 evaluates the riding manners of the passenger 4 in accordance with, for example, the number of times the passenger 4 is determined to have behaved inappropriately.

A user 4b who wishes to use the mobility service offered by the vehicle 2 operates the mobile terminal 40, such as a cellular phone or a tablet computer, carried by the user 4b, in order to request the dispatch of the vehicle 2 from the server 30.

The vehicle-mounted device 20, the server 30, and the mobile terminal 40 can communicate with each other through a network 5, which is composed of optical communication lines or the like. The server 30 is connected to the network 5 through, for example, a gateway or the like (not illustrated). The vehicle-mounted device 20 and the mobile terminal 40 are connected to the network 5 through, for example, wireless base stations (not illustrated) or the like.

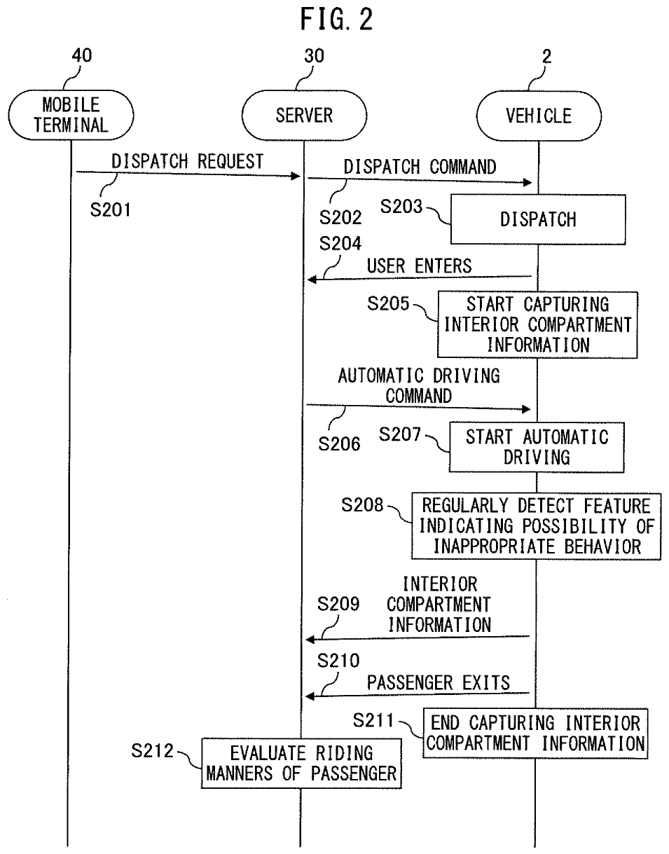

FIG. 2 is a sequence diagram showing an example of a riding manner evaluation process of the passenger 4 riding in the vehicle 2 that is under the automatic driving control, in the riding manner evaluation system 1 according to the first embodiment. In the sequence diagram of FIG. 2, the server 30, the vehicle 2, and the mobile terminal 40 communicate through the network 5.

The server 30 receives identification information of the user 4b, information regarding a present location and a destination of the user 4b together with a dispatch request, from the mobile terminal 40 of the user 4b who wishes to use the mobility service (step S201). The identification information of the user 4b is, for example, a user number assigned to the user 4b of the mobility service. The present location and the destination of the user 4b are designated by, for example, facility names, addresses, or combinations of latitude and longitude.

The server 30 retrieves vehicles 2 that are present within a certain distance from the present location of the user 4b, and selects an available vehicle 2 from the retrieved at least one vehicle 2. The server 30 sends a dispatch command to the vehicle 2 to move the vehicle 2 to the present location of the user 4b (step S202). Note that, when the vehicles 2 offer ride sharing services or the like, other passengers 4 may already be riding in the vehicles 2. In this case, for example, the server 30 may select, from the retrieved at least one vehicle 2, a vehicle 2 containing other passengers 4 who are travelling to a destination which is in the same direction as the destination of the user 4b.

Upon receiving the dispatch command from the server 30, the automatic driving control module 21 of the vehicle 2 moves the vehicle 2 to the present location of the user 4b, which is received together with the dispatch command (step S203).

When the user 4b enters the dispatched vehicle 2, the automatic driving control module 21 of the vehicle 2 detects the entry of the user 4b into the vehicle 2 by, for example, the in-vehicle camera 214, and informs the server 30 as such (step S204). The user 4b himself or herself, instead of the automatic driving control module 21 of the vehicle 2, may inform the server 30 of the entry of the user 4b into the vehicle 2 by operation of the mobile terminal 40.

The user 4b who is riding in the vehicle 2 is hereinafter referred to as a passenger 4. When the automatic driving control module 21 of the vehicle 2 detects the entry of the passenger 4, the vehicle-mounted device 20 of the vehicle 2 starts capturing interior compartment information that includes a video displaying the state of a compartment of the vehicle 2 captured by, for example, the in-vehicle camera 214 (step S205).

Upon receiving confirmation that the user 4b has entered the vehicle 2, the server 30 generates a driving route of the vehicle 2 from the present location of the vehicle 2 to the destination of the user 4b. Alternatively, for example, a car navigation system of the vehicle 2 may generate a driving route based on the information regarding the present location and the destination of the user 4b, which is received together with the dispatch command. When the vehicle 2 offers ride sharing services or the like, a driving route from the present location of the vehicle 2 to the nearest destination from among the destinations of the other passengers 4 who are already riding in the vehicle 2 and the destination of the user 4b is generated.

The server 30 sends the driving route to the automatic driving control module 21 of the vehicle 2, as necessary, and commands the automatic driving control module 21 of the vehicle 2 to perform automatic driving along the driving route (step S206). The automatic driving control module 21 of the vehicle 2 thereby starts the automatic driving of the vehicle 2 to the destination along the driving route (step S207).

While the vehicle 2 is being automatically driven by the automatic driving control module 21, the vehicle-mounted device 20 regularly detects a feature indicating the possibility of inappropriate behavior such as littering by the passenger 4 who is riding in the vehicle 2, from the captured interior compartment information (step S208). When the feature indicating the possibility of inappropriate behavior is detected, the vehicle-mounted device 20 sends the interior compartment information captured in a predetermined interval (for example, 10 seconds) including the time when the feature is detected, to the server 30 (step S209). The vehicle-mounted device 20 may send the captured interior compartment information to the server 30, whenever the interior compartment information is collected. Alternatively, the vehicle-mounted device 20 may temporarily hold the captured interior compartment information in a memory or the like, and thereafter collectively send the interior compartment information to the server 30.

After the vehicle 2 has arrived at the destination, the automatic driving control module 21 of the vehicle 2 detects that the passenger 4 has exited the vehicle 2 by, for example, the in-vehicle camera 214, and informs the server 30 as such (step S210). The passenger 4 himself or herself, instead of the automatic driving control module 21 of the vehicle 2, may inform the server 30 that he or she has exited the vehicle 2 by operation of the mobile terminal 40.

When the automatic driving control module 21 of the vehicle 2 detects the exit of the passenger 4, the vehicle-mounted device 20 of the vehicle 2 ends the capture of the interior compartment information, which represents the state of the compartment of the vehicle 2 that is under the automatic driving control (step S211).

The server 30 detects whether or not the passenger 4 has behaved inappropriately, based on the interior compartment information collected by the vehicle-mounted device 20 of the vehicle 2. The server 30 evaluates the riding manners of the passenger 4 in accordance with the number of times the passenger 4 is determined to have behaved inappropriately (step S212).

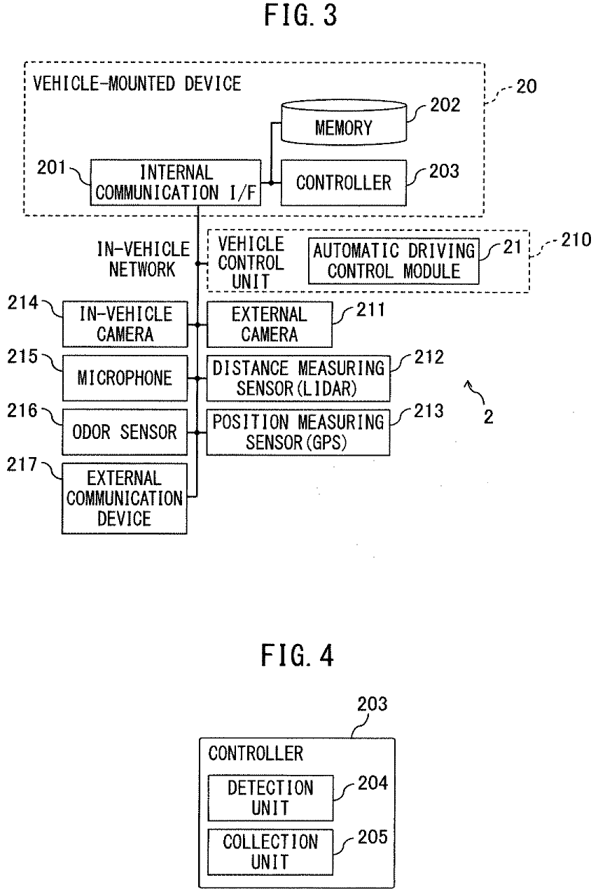

FIG. 3 is a hardware configuration diagram of the vehicle 2 according to the first embodiment. The vehicle 2 includes the vehicle-mounted device 20, a vehicle control unit 210, an external camera 211, a distance measuring sensor 212, a position measuring sensor 213, the in-vehicle camera 214, a microphone 215, an odor sensor 216, and an external communication device 217 that are connected to each other through an in-vehicle network. The vehicle 2 further includes the automatic driving control module 21. The in-vehicle network is, for example, a network that is in conformity with CAN (controller area network) standards.

The vehicle-mounted device 20 includes an internal communication interface (I/F) 201, a memory 202, and a controller 203 that are connected to each other through signal lines. The vehicle-mounted device 20 detects a feature indicating the possibility of inappropriate behavior such as littering by the passenger 4 who is riding in the vehicle 2, from the interior compartment information including the video of the compartment of the vehicle 2 captured by, for example, the in-vehicle camera 214 installed in the vehicle 2 that is under the automatic driving control. When the feature indicating the possibility of inappropriate behavior is detected, the vehicle-mounted device 20 sends the interior compartment information captured in the predetermined interval including the time when the feature is detected, to the server 30.

The internal communication I/F 201 is a communication I/F circuit through which the vehicle-mounted device 20 communicates with other vehicle-mounted devices of the vehicle 2 via the in-vehicle network.

The memory 202 has a recording medium such as an HDD (hard disk drive), an optical recording medium, or a semiconductor memory, and stores computer programs executed by the controller 203. The memory 202 stores data generated by the controller 203, data received by the controller 203 from other vehicle-mounted devices of the vehicle 2 through the in-vehicle network, and the like. The memory 202 also stores the interior compartment information that represents the state of the compartment of the vehicle 2 captured by the controller 203.

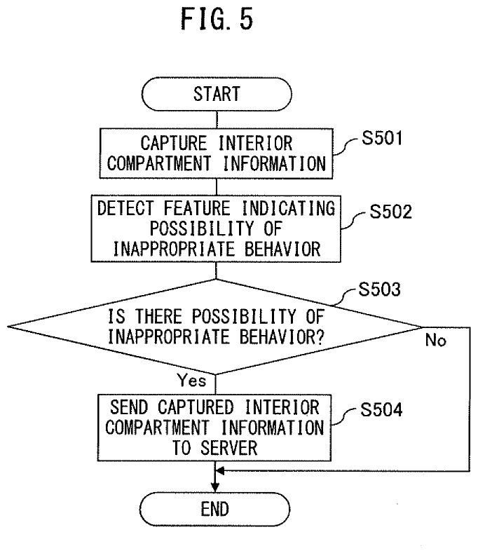

The controller 203 is one or more processors and peripheral circuits thereof that execute the computer programs for control and calculation in the vehicle-mounted device 20. The controller 203 performs a process for collecting the interior compartment information representing the state of the compartment of the vehicle 2, which will be described later with reference to FIG. 5.

The vehicle control unit 210 includes at least one automatic driving control module 21, and controls the accelerator, brake, and steering wheel of the vehicle 2 in accordance with signals outputted from the automatic driving control module 21. The vehicle control unit 210 transfers signals outputted from the external camera 211, distance measuring sensor 212, and position measuring sensor 213, which are described later, to the automatic driving control module 21.

The automatic driving control module 21 automatically controls the driving of the vehicle 2. The automatic driving control module 21 is configured so that, for example, the performance and function of automatic driving control can be updated. Therefore, the performance and function of the automatic driving control module 21 can be optimized in accordance with the mobility service offered by the vehicle 2. Note that, in applications in which improvements in the performance and function of the automatic driving control module 21 are not particularly necessary, the automatic driving control module 21 need not necessarily be configured so as to be updatable.

The external camera 211 captures and outputs a video of the surroundings of the vehicle 2. The video captured by the external camera 211 is used by the automatic driving control module 21 to automatically control the driving of the vehicle 2. The external camera 211 is disposed near a windshield of the vehicle 2, for example, with an imaging surface thereof facing toward the outside such that people or objects around the vehicle 2 are captured clearly.

The distance measuring sensor 212 measures and outputs distances to objects that are present ahead the vehicle 2 on an orientation basis. Distance information measured by the distance measuring sensor 212 is used, in the same manner, by the automatic driving control module 21 to automatically control the driving of the vehicle 2. The distance measuring sensor 212 is, for example, a LIDAR (light detection and ranging) installed in the vehicle 2.

The position measuring sensor 213 generates position information that represents the present location of the vehicle 2, and outputs the position information to the vehicle-mounted device 20. The position information generated by the position measuring sensor 213 is used by the automatic driving control module 21 to automatically control the driving of the vehicle 2, and is also transmitted to the server 30 through the network 5 so that the present location of the vehicle 2 can be understood by the server 30. The position measuring sensor 213 is, for example, a GPS (global positioning system) of the car navigation system installed in the vehicle 2.

The in-vehicle camera 214 is an example of a capture device and an imaging device, and captures the video of the compartment of the vehicle 2 and outputs the video to the vehicle-mounted device 20. The video captured by the in-vehicle camera 214 is used as an example of the interior compartment information representing the state of the compartment of the vehicle 2. A plurality of in-vehicle cameras 214 may be installed in the compartment of the vehicle 2. To clearly capture the state of the compartment of the vehicle 2, the in-vehicle camera 214 is disposed, for example, on the ceiling in front of the seat on which the passenger 4 is sitting, the rear surface of the seat in front of the passenger's seat, or the like.

The microphone 215 is an example of the capture device and a sound collection unit, and records the sound in the compartment of the vehicle 2 and outputs the sound to the vehicle-mounted device 20. The sound captured by the microphone 215 is used as an example of the interior compartment information representing the state of the compartment of the vehicle 2. A plurality of microphones 215 may be installed in the compartment of the vehicle 2. To clearly record the sound of the compartment of the vehicle 2, the microphone 215 is disposed, for example, on the ceiling in front of the seat on which the passenger 4 is sitting, the rear surface of the seat in front of the passenger's seat, or the like.

The odor sensor 216 is an example of the capture device, and measures the amount of a predetermined odor component such as an alcohol component or an oil component in the compartment of the vehicle 2, and outputs a measurement value to the vehicle-mounted device 20. The measurement value of the predetermined odor component measured by the odor sensor 216 is used as an example of the interior compartment information representing the state of the compartment of the vehicle 2. A plurality of odor sensors 216 may be installed in the compartment of the vehicle 2. To measure the odor of the compartment of the vehicle 2 with high accuracy, the odor sensor 216 is disposed, for example, on the ceiling, floor, or the like of the compartment of the vehicle 2.

The external communication device 217 is an in-vehicle terminal having a wireless communication function, and is, for example, an in-vehicle navigation system or a DCM (data communication module), as described in the non-patent literature (TOYOTA MOTOR CORPORATION, Mobility Service-specific EV “e-Palette Concept” [retrieved on Aug. 31, 2018], Internet<URL: https://newsroom.toyota.co.jp/jp/corporate/20508200.html>). The external communication device 217 accesses a wireless base station 6, which is connected to, for example, the network 5 through a gateway (not illustrated) and the like, whereby the external communication device 217 is connected to the network 5 through the wireless base station 6.

FIG. 4 is a functional block diagram of the controller 203 of the vehicle-mounted device 20 according to the first embodiment. The controller 203 is one or more processors and peripheral circuits thereof that execute computer programs for control and calculation in the vehicle-mounted device 20. The controller 203 includes a detection unit 204 and a collection unit 205. The detection unit 204 and the collection unit 205 are realized as, for example, a software module or firmware to which computer programs are written.

The detection unit 204 detects a feature indicating the possibility of inappropriate behavior by the passenger 4 riding in the vehicle 2, from the interior compartment information representing the state of the compartment of the vehicle 2 captured by the capture device installed in the vehicle 2 that is under the automatic driving control. Whenever the feature is detected, the collection unit 205 stores the interior compartment information captured in the predetermined interval including the time when the feature is detected, in the memory 202.

FIG. 5 is a flowchart showing an example of the process for collecting the interior compartment information of the vehicle 2 by the vehicle-mounted device 20 according to the first embodiment. The detection unit 204 and the collection unit 205 perform the process for collecting the interior compartment information, which represents the state of the compartment of the vehicle 2, in accordance with the following flowchart at, for example, predetermined control periods. Descriptions regarding contents that are the same as the sequence diagram of FIG. 2 have been omitted.

The detection unit 204 obtains the interior compartment information including the video of the compartment of the vehicle 2 from, for example, the in-vehicle camera 214 installed in the vehicle 2 that is under the automatic driving control (step S501). The detection unit 204 detects a feature indicating the possibility of inappropriate behavior such as littering by the passenger 4 riding in the vehicle 2, from the obtained interior compartment information (step S502).

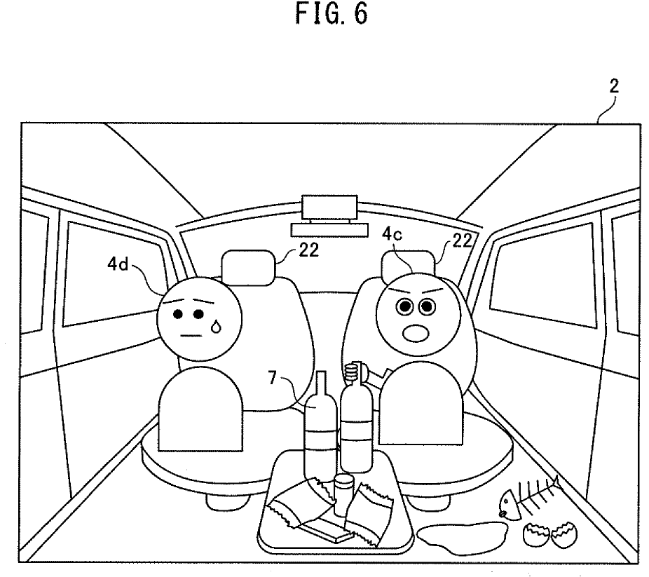

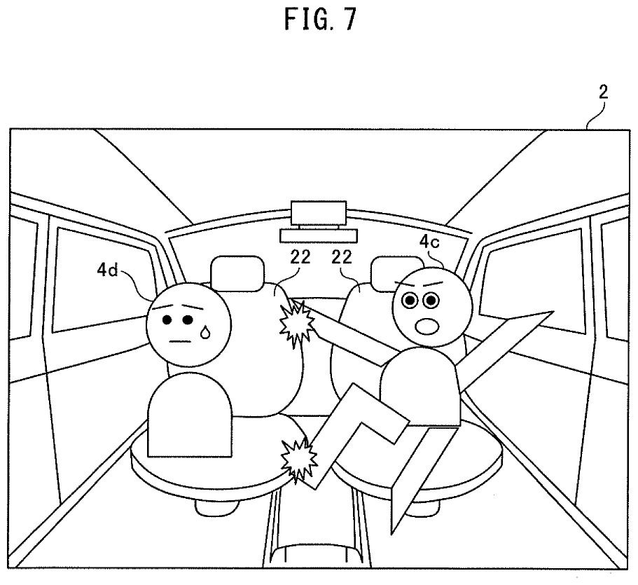

The feature indicating the possibility of inappropriate behavior need not necessarily indicate the occurrence of inappropriate behavior, as long as it indicates the mathematical possibility of inappropriate behavior. Whether or not inappropriate behavior has actually occurred is determined by an evaluation unit 306 of the server or a human, as described later. The feature indicating the possibility of inappropriate behavior will be specifically described later with reference to FIGS. 6 and 7.

Next, the collection unit 205 determines whether or not the feature indicating the possibility of inappropriate behavior has been detected from the interior compartment information (step S503). When the feature indicating the possibility of inappropriate behavior has been detected (YES in step S503), the collection unit 205 stores the interior compartment information captured in a predetermined interval including the time when the feature is detected, in the memory 202. The collection unit 205 sends the interior compartment information stored in the memory 202 to the server 30 (step S504), and ends the process for collecting the interior compartment information at the present control period.

Conversely, when the feature indicating the possibility of inappropriate behavior has not been detected (NO in step S503), the detection unit 204 and the collection unit 205 end the process for collecting the interior compartment information at the present control period.

Since the evaluation unit 306 of the server 30 or the human determines whether or not inappropriate behavior has actually occurred based on the interior compartment information including the feature indicating the possibility of inappropriate behavior collected by the collection unit 205, as described later, an incorrect determination can be prevented. Since only the interior compartment information in the predetermined interval including the feature indicating the possibility of inappropriate behavior is sent to the server 30, the amount of data sent from the vehicle-mounted device 20 to the server 30 is reduced as compared with the case of sending all of the interior compartment information to the server 30. The length of the predetermined interval is, for example, 5 seconds to 1 minute.

FIGS. 6 and 7 are drawings showing examples of the state of the compartment in which a passenger 4c is behaving inappropriately in the vehicle 2 according to the first embodiment. In the compartment of the vehicle 2 shown in FIGS. 6 and 7, the passenger 4c and a fellow passenger 4d, who is accidentally riding in the same vehicle 2, are sitting side-by-side in seats 22 of the vehicle 2.

In FIG. 6, the passenger 4c is drinking alcohol 7 while eating snack foods in the compartment of the vehicle 2, in which alcohol consumption is forbidden. The snack foods are scattered and the alcohol 7 spills around the seat 22 of the passenger 4c. Thus, the compartment of the vehicle 2 smells of the snack foods and the alcohol 7.

In FIG. 7, the passenger 4c is intoxicated, as in the case of FIG. 6, and arguing with the passenger 4d sitting in the adjacent seat 22. The passenger 4c damages the seat 22 of the passenger 4d by hitting and kicking. Thus, the compartment of the vehicle 2 is noisy.

The passenger 4d becomes annoyed by such inappropriate behaviors of the passenger 4c, and since crew members are not present in the vehicle 2 under the automatic driving control are not present in the vehicle 2, there is no one other than the passenger 4d himself or herself to warn the passenger 4c, which can be dangerous.

In such a case, the detection unit 204 obtains the video of the compartment of the vehicle 2 from, for example, the in-vehicle camera 214 installed in the vehicle 2. The detection unit 204 detects the appearance of a predetermined object that indicates the possibility of inappropriate behavior in the video of the compartment of the vehicle 2, as the feature indicating the possibility of inappropriate behavior. The predetermined object includes, for example, containers such as a food boxes, food cans, food bags, and plastic bottles, cigarettes, and the like. For example, as shown in FIG. 6, the detection unit 204 can detect whether the passenger 4c has brought snacks, the alcohol 7, and the like in the compartment of the vehicle 2 or has taken snacks and the alcohol 7 out of his or her bag, as the feature indicating the possibility of inappropriate behavior. The collection unit 205 sends the video of the predetermined interval (e.g., 10 seconds) including the time when the predetermined object appears in the video, to the server 30.

To detect the appearance of the predetermined object in the video, the detection unit 204 can use, for example, machine learning techniques. More specifically, the detection unit 204 can use a detector such as a DNN (deep neural network) which has been taught to detect predetermined objects from an inputted image. The detection unit 204 inputs frame images of the video to the detector in the order in which they are captured. When an output value that indicates the detection of a predetermined object is outputted from the detector, the detection unit 204 determines that the predetermined object has appeared in the video.

The detection unit 204 may detect, for example, a change in the color of a predetermined fixture in the video of the compartment of the vehicle 2, as the feature indicating the possibility of inappropriate behavior. The predetermined fixture may include, for example, the seats 22 disposed in the compartment of the vehicle 2, floor mats arranged on the floor in the vicinity of the seats 22, and the like. As shown in FIG. 6, the detection unit 204 can thereby detect whether, for example, the passenger 4c has spilled the alcohol 7 or vomited on the floor mat, as the feature indicating the possibility of inappropriate behavior.

To detect a change in the color of the predetermined fixture in the video of the compartment of the vehicle 2, the detection unit 204 compares, for example, a present frame image of the video with a past frame image of a prior predetermined time (e.g., one minute). When the average value of at least one of color components of, for example, R (red), G (green), and B (blue) of the pixel values in a region of the predetermined fixture of the frame image has changed by a predetermined threshold value or more, the detection unit 204 can determine that the color of the predetermined fixture has changed in the video.

The detection unit 204 may detect, for example, a change in the shape of a predetermined fixture in the video of the compartment of the vehicle 2, as the feature indicating the possibility of inappropriate behavior. The predetermined fixture may include, for example, the seats 22 disposed in the compartment of the vehicle 2, a door of the vehicle 2, and the like. As shown in FIG. 7, the detection unit 204 can thereby detect whether, for example, the passenger 4c has damaged the seat 22 by hitting and kicking, as the feature indicating the possibility of inappropriate behavior.

To detect a change in the shape of the predetermined fixture in the video of the compartment of the vehicle 2, the detection unit 204 compares, for example, a present frame image of the video with a past frame image of a prior predetermined time (e.g., one minute). When the outline of the predetermined fixture, which is obtained by applying an edge enhancement process to a region of the predetermined fixture of the frame image, has moved by a certain pixel width or more between the present frame image and the past frame image, the detection unit 204 can determine that the shape of the predetermined fixture has changed in the video.

The detection unit 204 may detect whether, for example, the distance between the passengers 4c and 4d in the video of the compartment of the vehicle 2 has been reduced to a predetermined threshold value or less, as the feature indicating the possibility of inappropriate behavior. As shown in FIG. 7, the detection unit 204 can thereby detect whether, for example, the passenger 4c has come close to the passenger 4d to fight with the passenger 4d, as the feature indicating the possibility of inappropriate behavior.

To detect whether the distance between the passengers 4c and 4d has been reduced to the predetermined threshold value or less, the detection unit 204 can use, for example, a detector such as a DNN which has been taught to detect individuals from an inputted image. The detection unit 204 inputs frame images of the video to the detector in the order in which they are captured. When the shortest distance between the persons detected by the detector becomes a certain pixel width or less, the detection unit 204 determines that the distance between the passengers 4c and 4d in the video has become the predetermined threshold value or less.

The detection unit 204 may detect whether, for example, the average value of the sound level in the compartment of the vehicle 2 captured by the microphone 215 installed in the vehicle 2 in a predetermined interval has exceeded a predetermined threshold value, as the feature indicating the possibility of inappropriate behavior. The predetermined interval may be, for example, 0.1 seconds to 10 seconds. As shown in FIG. 7, the detection unit 204 can thereby detect the sound of the passenger 4c fighting with the passenger 4d or hitting and kicking the seat 22, as the feature indicating the possibility of inappropriate behavior. In this case, the collection unit 205 sends a measurement value of the sound of the compartment in a predetermined interval including the time when the average value of the sound level in the compartment of the vehicle 2 in the predetermined interval has exceeded the predetermined threshold value, to the server 30.

The detection unit 204 may detect whether, for example, a measurement value of a predetermined odor component measured by the odor sensor 216 installed in the vehicle 2 has exceeded a predetermined threshold value, as the feature indicating the possibility of inappropriate behavior. The predetermined odor component may be, for example, an alcohol component, an oil component, or the like. As shown in FIG. 6, the detection unit 204 can thereby detect whether, for example, the passenger 4c has scattered snack foods or spilled the alcohol 7, as the feature indicating the possibility of inappropriate behavior. In this case, the collection unit 205 sends the measurement value of the odor component in a predetermined interval including the time when the measurement value of the odor component has exceeded the predetermined threshold value, to the server 30.

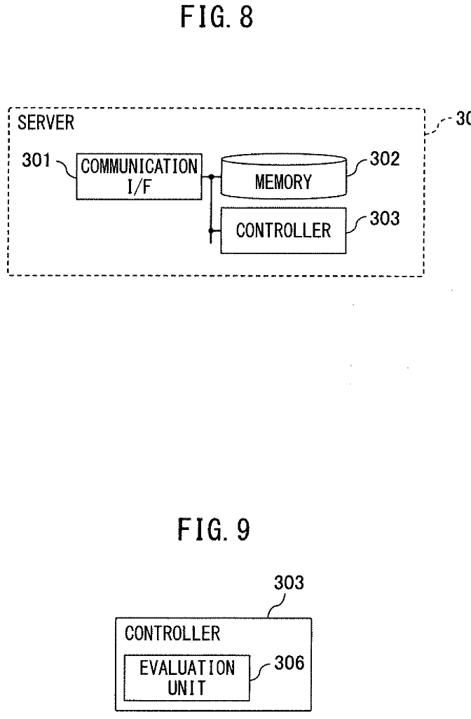

FIG. 8 is a hardware configuration diagram of the server 30 according to the first embodiment. The server 30 includes a communication I/F 301, a memory 302, and a controller 303 that are connected to each other through signal lines.

The communication I/F 301 is a communication I/F circuit through which the server 30 is connected to the network 5 through, for example, a gateway or the like. The communication I/F 301 is configured to be able to communicate with the vehicle-mounted device 20 of the vehicle 2 and the mobile terminal 40 through the network 5.

The memory 302 includes a recording medium such as an HDD (hard disk drive), an optical recording medium, or a semiconductor memory, and stores computer programs executed by the controller 303. The memory 302 stores data generated by the controller 303, data received by the controller 303 through the network 5, and the like. The memory 302 stores the type, version, or the like of the automatic driving control module 21 of the vehicle 2, as an example of information regarding the vehicle 2. The memory 302 stores the identification information of the passenger 4 (user 4b), as an example of information regarding the passenger 4. The memory 302 stores the interior compartment information indicating the state of the compartment of the vehicle 2 received from the vehicle-mounted device 20 of the vehicle 2.

FIG. 9 is a functional block diagram of the controller 303 of the server 30 according to the first embodiment. The controller 303 is one or more processors and peripheral circuits thereof that execute computer programs for control and calculation in the server 30. The controller 303 includes the evaluation unit 306. The evaluation unit 306 is realized as, for example, a software module or firmware to which computer programs are written.

The evaluation unit 306 stores the interior compartment information received from the vehicle-mounted device 20 in the memory 302. The evaluation unit 306 determines whether or not the passenger 4 has behaved inappropriately based on the interior compartment information stored in the memory 302, and evaluates the riding manners of the passenger 4 in accordance with, for example, the number of times the passenger 4 is determined to have behaved inappropriately.

The evaluation unit 306 can use, for example, machine learning techniques to determine whether or not the passenger 4 has behaved inappropriately. More specifically, the evaluation unit 306 can use a determination unit such as a DNN which has been taught to output whether or not inappropriate behavior has occurred and who has behaved inappropriately from an inputted image. The evaluation unit 306 inputs the interior compartment information received from the vehicle-mounted device 20 to the determination unit. When an output value that indicates that inappropriate behavior has occurred is outputted from the determination unit, the evaluation unit 306 determines that the person outputted from the determination unit has behaved inappropriately.

An evaluation value of the riding manners of the passenger 4 evaluated by the evaluation unit 306 is stored in the memory 302 or sent to another server through the communication I/F 301, and is used as information to identify a passenger 4 who frequently behaves inappropriately.

Note that, instead of the evaluation unit 306 that evaluates the riding manners of the passenger 4, the controller 203 of the vehicle-mounted device 20 may include an evaluation unit having the same function as the evaluation unit 306 of the server 30, to evaluate the riding manners of the passenger 4 based on the interior compartment information stored in the memory 202. Alternatively, for example, a human may evaluate the riding manners of the passenger 4 based on the interior compartment information stored in the memory 302.

As described above, the riding manner evaluation apparatus according to the present embodiment detects the feature indicating the possibility of inappropriate behavior by the passenger riding in the vehicle, from the interior compartment information representing the state of the compartment of the vehicle captured by the capture device installed in the vehicle that is under the automatic driving control. Whenever the feature is detected, the riding manner evaluation apparatus stores the interior compartment information captured in the predetermined interval including the time when the feature is detected.

Therefore, in the riding manner evaluation apparatus according to the present embodiment, the evaluation unit of the riding manner evaluation apparatus or the human can evaluate the riding manners of the passenger using the vehicle that is under the automatic driving control, based on the interior compartment information stored in the memory, and identify passengers who frequently behave inappropriately.

[Second Embodiment] According to another embodiment, the process for collecting the interior compartment information of the vehicle 2 by the vehicle-mounted device 20, as shown in the flowchart of FIG. 5, can instead be performed by the server 30. This reduces the processing burden of the controller 203 of the vehicle-mounted device 20.

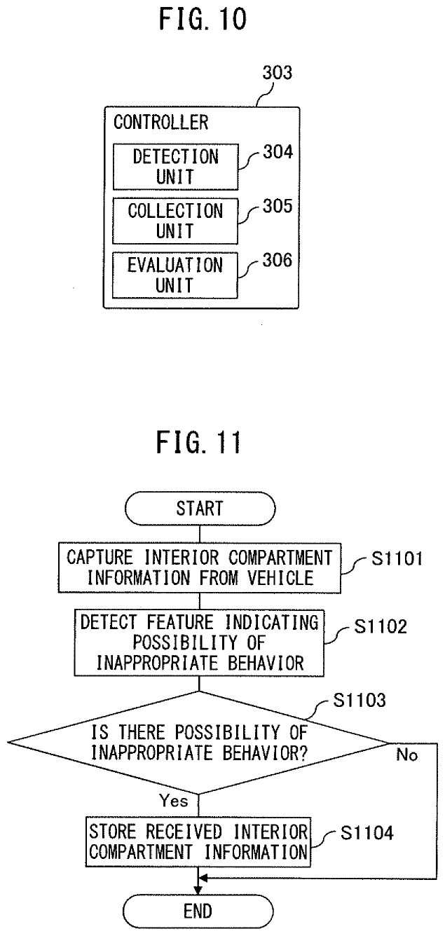

FIG. 10 is a functional block diagram of a controller 303 of a server 30 according to a second embodiment. The controller 303 includes a detection unit 304, a collection unit 305, and an evaluation unit 306. The detection unit 304 and the collection unit 305 have the same functions as the detection unit 204 and the collection unit 205 of the vehicle-mounted device 20. The other components are identical to those of the first embodiment, and thus, only differences from the first embodiment will be described below.

FIG. 11 is a flowchart showing an example of a process for collecting interior compartment information of a vehicle 2 by the server 30 according to the second embodiment. The detection unit 304 and the collection unit 305 perform the process for collecting the interior compartment information, which represents the state of the compartment of the vehicle 2, in accordance with the following flowchart at, for example, predetermined control periods.

The detection unit 304 receives interior compartment information including a video of the compartment of the vehicle 2 from a vehicle-mounted device 20 of the vehicle 2 that is under automatic driving control (step S1101). The detection unit 304 detects the feature indicating the possibility of inappropriate behavior such as littering by a passenger 4 riding in the vehicle 2, from the received interior compartment information (step S1102).

Next, the collection unit 305 determines whether or not the feature indicating the possibility of inappropriate behavior has been detected from the interior compartment information (step S1103). When the feature indicating the possibility of inappropriate behavior has been detected (YES in step S1103), the collection unit 305 stores the interior compartment information captured in a predetermined interval including the time when the feature is detected in a memory 302 (step S1104), and ends the process for collecting the interior compartment information at the present control period.

Conversely, when feature indicating the possibility of inappropriate behavior has not been detected (NO in step S1103), the detection unit 304 and the collection unit 305 end the process for collecting the interior compartment information at the present control period.

As described above, even when the riding manner evaluation apparatus is configured as a server that receives the interior compartment information from the vehicle through a network, the same effects as the first embodiment, in which the riding manner evaluation apparatus is configured as a vehicle-mounted device, as described in the first embodiment, can be obtained.

The above embodiments are merely examples for carrying out the present invention, and the technical scope of the present invention is not limited by the embodiments. In other words, the present invention can be carried out in various forms without deviating from the technical principles or main features thereof

According to another modification example, the riding manner evaluation apparatus detects a feature indicating the possibility of exceptional behavior such as trash collection by the passenger 4 from the interior compartment information. Whenever this feature is detected, the riding manner evaluation apparatus may store the interior compartment information captured in the predetermined interval including the time when the feature is detected, in the memory. The evaluation unit of the riding manner evaluation apparatus or the human can thereby evaluate the riding manners of the passenger 4 with high accuracy based on both the inappropriate behavior and exceptional behavior.

The detection unit 204 or 304 obtains a video of the compartment of the vehicle 2 from, for example, the in-vehicle camera 214 installed in the vehicle 2. The detection unit 204 or 304 detects the disappearance of a predetermined object that indicates the possibility of inappropriate behavior from the video of the compartment of the vehicle 2, as the feature indicating the possibility of exceptional behavior. The predetermined object includes, for example, containers such as food boxes, food cans, food bags, and plastic bottles, cigarettes, and the like.

To detect the disappearance of the predetermined object from the video, the detection unit 204 or 304 can use, for example, machine learning techniques. More specifically, the detection unit 204 or 304 can use a detector such as a DNN which has been taught to detect predetermined objects from an inputted image. The detection unit 204 or 304 inputs frame images of the video to the detector in the order they are captured. When the detector stops outputting an output value that indicates the detection of a predetermined object, the detection unit 204 or 304 determines that the predetermined object has disappeared from the video.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A riding manner evaluation apparatus comprising:
a memory; and
a processor configured to
detect a feature indicating the possibility of inappropriate behavior by a passenger riding in a vehicle, from interior compartment information representing the state of a compartment of the vehicle captured by a capture device installed in the vehicle that is under automatic driving control; and
collect, whenever the feature is detected, the interior compartment information captured in a predetermined interval including the time when the feature is detected.

2. The riding manner evaluation apparatus according to claim 1, wherein the processor determines whether or not the passenger has behaved inappropriately based on the interior compartment information stored in the memory, and that evaluates the riding manners of the passenger in accordance with the number of times the passenger is determined to have behaved inappropriately.

3. The riding manner evaluation apparatus according to claim 1, wherein
the capture device includes an imaging device installed in the vehicle;
the interior compartment information includes a video of the compartment of the vehicle captured by the imaging device; and
the processor detects, from the video, an appearance of a predetermined object indicating the possibility of inappropriate behavior, a change in the shape or color of a predetermined fixture in the vehicle, or a reduction in the distance between the passenger and another passenger to a predetermined threshold value or less, as the feature.

4. The riding manner evaluation apparatus according to claim 1, wherein
the capture device includes a sound collection device installed in the vehicle;
the interior compartment information includes sound of the compartment of the vehicle recorded by the sound collection device; and
the processor detects whether the average value of a sound level in a predetermined time has exceeded a predetermined threshold value, as the feature.

5. The riding manner evaluation apparatus according to claim 1, wherein
the capture device includes an odor sensor installed in the vehicle;
the interior compartment information includes a measurement value of a predetermined odor component measured by the odor sensor; and
the processor detects whether the measurement value has exceeded a predetermined threshold value, as the feature.

6. The riding manner evaluation apparatus according to claim 1, wherein the riding manner evaluation apparatus is configured as a server that receives the interior compartment information from the vehicle including the capture device through a network.

7. The riding manner evaluation apparatus according to claim 1, wherein the riding manner evaluation apparatus is configured as a vehicle-mounted device that is installed in the vehicle together with the capture device.

8. A riding manner evaluation system including a server and a vehicle-mounted device that are communicatively connected to each other through a network, the riding manner evaluation system comprising:
the vehicle-mounted device that detects a feature indicating the possibility of inappropriate behavior by a passenger riding in a vehicle, from interior compartment information representing the state of a compartment of the vehicle captured by a capture device installed in the vehicle that is under automatic driving control, and that sends, when the feature is detected, the interior compartment information captured in a predetermined interval including the time when the feature is detected, to the server; and
the server that stores the interior compartment information received from the vehicle-mounted device in a memory.

9. A riding manner evaluation method comprising the steps of:
detecting a feature indicating the possibility of inappropriate behavior by a passenger riding in a vehicle, from interior compartment information representing the state of a compartment of the vehicle captured by a capture device installed in the vehicle that is under automatic driving control; and
storing, whenever the feature is detected, the interior compartment information that is obtained in a predetermined interval including the time when the feature is detected, in a memory.
